(19) United States
(12) Patent Application Publication
(10) Pub. No.: US 2026/0280334 A1
(43) Pub. Date: Sep. 17, 2026

(54) FAST CHARGING PORT FOR DC UPS

(71) Applicant: Schneider Electric IT Corporation, Foxborough, MA (US)

(72) Inventors: Hermant Agrawal, Bangalore (IN); Sudhir Shenoy, Bangalore (IN); K Gowri Shenoy, Bangalore (IN)

(21) Appl. No.: 19/561,719

(22) Filed: Mar. 10, 2026

(30) Foreign Application Priority Data
Mar. 11, 2025 (IN) 202511021764

(51) Int. Cl. H02J 9/06; H02J 1/10; H02J 1/16

(52) U.S. Cl. CPC H02J 9/061; H02J 1/10; H02J 1/16

(57) ABSTRACT

An uninterruptible power supply (UPS) is presented. The UPS includes a first input configured to receive first DC power; a second input configured to receive second DC power; an output configured to provide a first output DC power to a load; and a power train including at least one energy-storage interface configured to be coupled to an energy-storage device, the power train being coupled to the first input, the second input, and the output, and being configured to direct at least a portion of the first DC power from the first input to the output to provide the first output DC power to the load, and direct, via the at least one energy-storage interface, the second DC power as a second output DC power to the energy-storage device.

### CROSS-REFERENCE TO RELATED APPLICATIONS

This application claims the benefit of priority to Indian Patent Application No. 202511021764, filed on Mar. 11, 2025, entitled “FAST CHARGING PORT FOR DC UPS,” which is incorporated by reference herein in its entirety.

### BACKGROUND

Power devices, such as uninterruptible power supplies (UPSs), may be used to provide regulated, uninterrupted power for sensitive and/or critical loads, such as computer systems and other data-processing systems. Existing UPSs include online UPSs, offline UPSs, line-interactive UPSs, as well as others. UPSs may provide output power to a load. The output power may be derived from a primary source of power, such as a utility-mains source, and/or derived from a back-up source of power, such as an energy-storage device.

Output of a UPS may be AC or DC depending on requirement of the load being powered by the UPS. On this basis, the UPSs may be categorized as AC UPS (i.e. the ones which have AC output), and DC UPS (i.e. the ones which have DC output). Irrespective of the output being AC or DC, a UPS may be designed to work with AC input or DC input, and internal circuitry of the UPS takes care of the power conversion necessary to satisfy requirements of the load being powered by the UPS.

### SUMMARY

According to at least one aspect of the present disclosure, an uninterruptible power supply (UPS) is presented, comprising: a first input configured to receive first DC power; a second input configured to receive second DC power; an output configured to provide a first output DC power to a load; and a power train including at least one energy-storage interface configured to be coupled to an energy-storage device, the power train being coupled to the first input, the second input, and the output, and being configured to direct at least a portion of the first DC power from the first input to the output to provide the first output DC power to the load, and direct, via the at least one energy-storage interface, the second DC power as a second output DC power to the energy-storage device.

In some examples, the power train includes a first path for the first DC power and a second path for the second DC power. In some examples, the first path is configured to receive the first DC power and provide the first DC power to a common conducting path; and the second path is configured to receive the second DC power and provide the second DC power to the common conducting path. In some examples, the first path and the second path are independent of one another. In some examples, the power train further comprises a power interface coupled to the first input and configured to receive the first DC power from the first input; and an output interface coupled to the output and configured to receive the portion of the first DC power and provide the output DC power to the output. In some examples, the output interface is further configured to condition power provided by the power interface to have a voltage rated for use by the load. In some examples, the at least one energy-storage interface is further configured to condition power to have a voltage rated for use by the energy-storage device. In some examples, the power train further comprises a power flow circuit coupled to the first input and the second input. In some examples, the power train further comprises a power interface coupled to the second input and configured to receive the second DC power. In some examples, the at least one energy-storage interface conditions the second DC power to be rated for the energy-storage device. In some examples, the UPS further comprises at least one controller, wherein the power train further comprises a power interface coupled to the first input and an output interface coupled to the output, and wherein the at least one controller is configured to: control the power interface to condition the first DC power to provide first conditioned power; control the output interface to condition at least a portion of the first conditioned power to provide the first output DC power to the output; and control the at least one energy-storage interface to condition the second DC power to provide the second output DC power to the at least one energy-storage device. In some examples, the UPS further comprises at least one controller, wherein the at least one controller is configured to: control the power train to provide the first output DC power such that the first output DC power includes a first portion of the first DC power and a first portion of the second DC power, and control the power train to provide the second output DC power such that the second output DC power includes a second portion of the first DC power and a second portion of the second DC power. In some examples, the UPS further comprises at least one controller, wherein the at least one controller is configured to control the at least one energy-storage interface to condition the second output DC power to have a voltage rated for the energy-storage device. In some examples, the second input is configured to perform at least one action from a list of actions including: sending firmware updates, sending user interface information, sending configurable parameter values, receiving firmware updates, receiving user interface information, and receiving configurable parameter values.

According to at least one aspect of the present disclosure, a method of managing power in an uninterruptible power supply having a first input, a second input, and an output configured to be coupled to a load, is presented, the method comprising: receiving, at the first input, first DC power having a first voltage; receiving, at the second input, second DC power having a second voltage; responsive to receiving the first DC power, providing at least a portion of the first DC power to the load via the output; and responsive to receiving the second DC power, providing the second DC power to an energy-storage device via an energy-storage interface.

In some examples, the method further comprises responsive to receiving the first DC power, determining that a power level of the first DC power is below a threshold power parameter; and responsive to determining that the power level of the first DC power is below the threshold power parameter, and prior to receiving the second DC power, operating a power interface to couple the second input to the energy-storage device. In some examples, the power level is based on at least one member of a set comprising the first voltage, a current, and a power of the first DC power, and the threshold power parameter is a value corresponding to at least one of the first voltage, the current, or the power of the first DC power. In some examples, the method further comprises monitoring the first DC power; determining, based on monitoring the first DC power, that a power level of the first DC power is above a threshold power; and responsive to determining that the power level is above the threshold power, stop drawing the second DC power. In some examples, the method further comprises deriving, by a power train, the first DC power from a first power source; and deriving, by the power train, the second DC power from at least one second power source not including the first power source.

According to at least one aspect of the present disclosure, at least one non-transitory computer-readable medium is presented, containing thereon instructions for operating an uninterruptible power supply (UPS) including a first input, a second input, an output configured to be coupled to a load, and at least one energy-storage interface configured to be coupled to an energy-storage device, the instructions instructing at least one processor to control the UPS to: receive, at the first input, first DC power having a first voltage; receive, at the second input, second DC power having a second voltage; responsive to receiving the first DC power, provide at least a portion of the first DC power to the load; and responsive to receiving the second DC power, provide the second DC power to the energy-storage device via the energy-storage interface.

In some examples, the instructions further instruct the at least one processor to: determine whether a power level of the first DC power is above a threshold power level; and responsive to determining that the power level of the first DC power is below the threshold power level, and prior to receiving the second DC power, operate a power interface to couple the second input to the energy-storage device, wherein the power level is based on at least one member of a set comprising the first voltage, a current, and a power of the first DC power, and the threshold power level is a value corresponding to at least one of the first voltage, the current, or the power of the first DC power. In some examples, the instructions further instruct the at least one processor to: control the UPS to monitor the first DC power to determine whether a power level of the first DC power is above a threshold power level; and responsive to determining that the power level is above the threshold power, control the UPS to stop drawing the second DC power.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a power system according to an example;

FIG. 2 illustrates a block diagram of a power system according to an example;

FIG. 3 illustrates a block diagram of a power system according to an example;

FIG. 4 illustrates a process for providing power according to an example; and

FIG. 5 illustrates a block diagram of a power system according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Uninterruptible power supplies (“UPSs”) may be used to provide uninterrupted power to a load where main power to the load is interrupted. Some UPSs are connected to a primary power source, such as a utility mains supply, and a backup power source, such as an energy-storage device (for example, a battery, flywheel, capacitor, and so forth). While main power is available from the primary power source, the UPS may power the load using the main power. If main power is interrupted (for example, because of a blackout condition), the UPS may power the load using power drawn from the energy-storage device. If the energy-storage device is at least partially discharged, the UPS may recharge the energy-storage device using main power when the primary power source is again online.

In some situations, the UPS may first use the main power to power the load and, using whatever residual power remains after satisfying the load requirements, optionally recharge the energy-storage device. However, in some implementations, the residual power may be small and may result in recharging the energy-storage device slowly. For example, consider a DC load that is configured to be powered by an AC utility grid. DC loads are often sold with AC/DC converters to enable the DC load to be powered by the AC grid via the AC/DC converter. A DC UPS may be inserted between the AC/DC converter and the DC load, and may therefore provide uninterruptible power to the DC load from either the AC/DC converter or a backup energy-storage device. However, because the AC/DC converter may be specifically rated to power the DC load, the AC/DC converter may provide only a small amount of residual power beyond the rated power of the load.

This non-limiting example illustrates only one scenario in which minimal residual power is available for a power device such as a UPS to recharge an energy-storage device. In other examples, a converter coupled between a utility grid and a UPS may include an AC/AC converter, DC/DC converter, DC/AC inverter, and so forth, configured to convert utility power to power suitable for the load and/or the UPS. In still other examples, a UPS may be connected directly to a main power source (rather than via a converter, for example) but may still have access to limited residual power after satisfying the load requirements. In other examples, a power device other than a UPS may similarly have access to minimal residual power.

Examples of UPSs disclosed herein may allow for fast-charging of one or more connected energy-storage devices by providing an additional power port. Additional power may be drawn from the main power source via the additional power port, either directly or via a converter connected to the main power source. For example, if the UPS is coupled to an AC/DC converter downstream from an AC utility grid, the UPS may include an additional power port configured to be coupled to the AC/DC converter output, or directly to the AC utility grid, or via a different converter coupled to the AC utility grid. The additional power may be used to power the load and/or to recharge the energy-storage device.

In at least one example, a UPS may receive power from a first power source (for example, a main power source) and determine if the power received from first power source is able to effectively and/or efficiently both power the load and recharge the energy-storage device coupled to the UPS. If the power is not able to effectively and/or efficiently power the load and recharge the energy-storage device, the UPS may draw power from a second power-source connection to supplement the power drawn from the first power source. The second power-source connection may be coupled, either directly or downstream from, the first power source. Examples of the first and the second power source are two different AC/DC converters downstream from an AC utility grid and upstream of the UPS. The UPS may use the additional power to address the difference in power needed to effectively and/or efficiently power the load and recharge the energy-storage device.

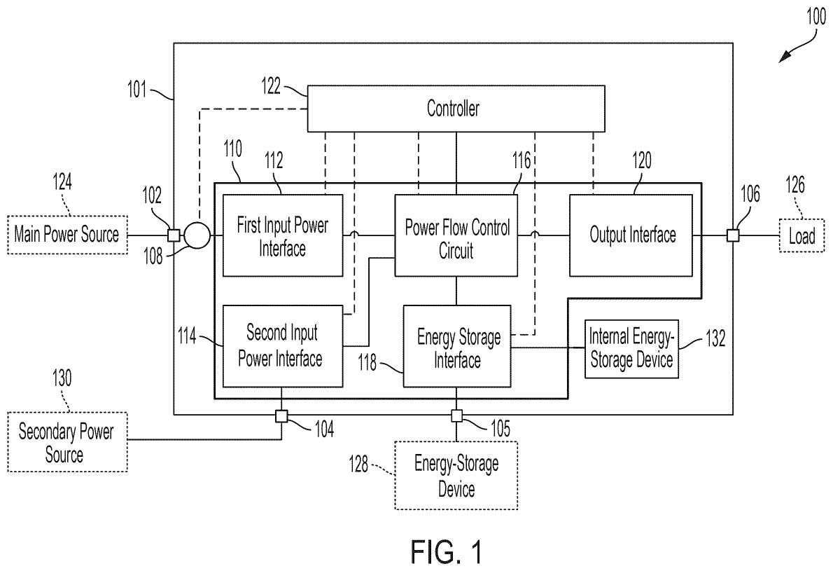

FIG. 1 illustrates a power system 100 for powering a load 126 using an uninterruptible power supply 101 (“UPS 101”) according to an example. The UPS 101 includes a first input 102, a second input 104, an output 106, one or more sensors 108 (“sensor 108”) and a power train 110. The power train 110 includes a first input interface 112 (“first interface 112”), a second input interface 114 (“second interface 114”), a power flow control circuit 116 (“flow circuit 116”), an energy-storage interface 118 (“storage interface 118”), and an output interface 120. The UPS 101 also includes an at least one controller (“controller 122”), an internal energy-storage device 132 (“internal storage 132”), and may include a bidirectional connection 105. The power system 100 also includes a main power source 124, one or more loads 126 (“load 126”), a secondary power source 130, and may include one or more energy-storage devices 128 (“storage device 128”).

The UPS 101 is configured to be coupled to the main power source 124 via the first input 102. The first input 102 is configured to be coupled to the main power source 124, and is coupled to the first interface 112 (and therefore to the power train 110). The first input 102 may also be coupled to the sensor 108. For example, the sensor 108 may be configured to sense parameters related to the connection between the first input 102 and the first interface 112, such as a voltage and/or current on the connection.

The first interface 112 is coupled to the flow circuit 116 via a first connection, and to the first input 102 via a second connection. The second interface 114 is coupled to the second input 104 via a first connection, and to the flow circuit 116 via a second connection. The second input 104 is configured to be coupled to the secondary power source 130, and is coupled to the second interface 114.

The flow circuit 116 is coupled to the first interface 112 via a first connection, the storage interface 118 via a second connection, the output interface 120 via a third connection, the controller 122 via a fourth connection, and the second interface 114 via a fifth connection.

The storage interface 118 is coupled to the flow circuit 116 via a first connection, to the bidirectional connection 105 via a second connection, and to the internal storage 132 via a third connection. The bidirectional connection 105 is configured to be coupled to the storage device 128, and is coupled to the storage interface 118.

The output interface 120 is coupled to the output 106 via a first connection and to the flow circuit 116 via a second connection. The output 106 is coupled to the output interface 120 and is configured to be coupled to the load 126.

The controller 122 is coupled to the flow circuit 116, and may be coupled (for example, communicatively coupled) to any component of the UPS 101, including but not limited to the sensor 108, the power train 110, the first interface 112, the second interface 114, the output interface 120, and/or the storage interface 118.

The main power source 124 may be the primary power source for the load 126. The main power source 124 may be a utility main power line, a power generator or power plant, or any other source of power. In some examples, the main power source 124 may include a power converter configured to convert main power to a form acceptable for use by the UPS 101 or the load 126. For example, as discussed above, the main power source 124 may include an AC/DC converter configured to convert AC power (for example, grid power) to DC power. Accordingly, in some examples, the main power source 124 may provide AC power, and in some examples the main power source 124 may provide DC power. The power provided by the main power source 124 is provided at the first input 102 of the UPS 101.

The secondary power source 130 is a power source that provides power to the second input 104. In some examples, the secondary power source 130 and main power source 124 may be the same power source. In other examples, the secondary power source 130 may be a different power source than the main power source 124. In some examples, the main power source 124 is a power supply that converts power from the grid or utility to power having characteristics (for example, voltage, current, frequency, and so forth) appropriate for input into the UPS 101. In various examples, the secondary power source 130 may be the grid or utility power source itself, whereas the main power source 124 may include an AC/DC converter coupled to the same utility grid. In some examples, the secondary power source 130 may include an AC/DC converter coupled to a utility grid. In some of these examples, the secondary power source 130 may be able to provide more power than the main power source 124 can.

The load 126 consumes power output by the UPS 101 at the output 106. The load 126 may be any device that uses power to operate, for example, a light, a computer, an appliance, a data server, or any other type of electronic device.

The storage device 128 and the internal storage 132 store energy. Stored energy may be derived via power from the first input 102 or the second input 104. The storage device 128 and the internal storage 132 may be any type of device capable of storing energy, such as a battery. In some modes of operation, the storage device 128 and the internal storage 132 may provide power for the load. For example, the storage device 128 and the internal storage 132 may provide energy to the storage interface 118, which may be provided to the flow circuit 116. The flow circuit 116 may then distribute some of the energy to one or both of the controller 122 and the output interface 120. The output interface can then provide the power to the load 126 via the output 106.

As noted above, the UPS 101 may receive power from the secondary power source 130 via the second input 104. In some examples, the UPS 101 may also transmit and/or receive data via the second input 104. For example, the second input 104 may include a USB connection and/or another connection with the capability to receive and/or transmit data. For example, the UPS 101 may receive information at the second input 104 (including, for example, updates to the UPS 101) or transmit information from the UPS 101. Accordingly, while the second input 104 is referred to as an “input” for purposes of brevity, in some examples, information may be transmitted from the UPS 101 via the second input 104.

The second input 104 may transmit and/or receive information to or from devices other than, and/or in addition to, the secondary power source 130. For example, the UPS 101 may receive information such as firmware updates to the controller 122. The UPS 101 may transmit, via the second input 104, information including power characteristics, such as voltage, current, frequency, load characteristics, and other traits of the power system 100 to external devices. In some examples, the second input 104 may be used as a user interface for setting the configurable parameters of the UPS 101, such as the output voltage, output current limit, output power limit, and so forth. In other examples, the second input 104 may be used to transmit information about the UPS 101, such as the battery status, output power, backup time, temperature, and so forth, to external devices.

In some examples, power from the main power source 124 and/or secondary power source 130 may be provided to the load 126 as well as the storage device 128 and the internal storage 132. In some examples, the main power source 124 may be able to provide enough power to power the load 126 but not enough power to effectively recharge the storage device 128 and/or the internal storage 132. In examples where the main power source 124 cannot provide enough power to both power the load 126 and effectively recharge the storage device 128 and/or the internal storage 132, additional power may be drawn from the secondary power source 130 to power the load 126 and recharge the storage device 128 and/or the internal storage 132.

The UPS 101 may receive power from power sources at the first input 102 and/or the second input 104. In some examples, the UPS 101 may also be able to receive power from the output 106 and may be able to provide the power received from the load 126 to the storage device 128 and/or the internal storage 132 and/or to the power sources 124, 130 (for example, if the load 126 is of regenerative type then it may generate excess power that may be returned to the main power source 124).

The first input 102 is configured to receive first input power from a power source such as the main power source 124. The second input 104 is configured to receive second input power from a power source such as the secondary power source 130. The output 106 is configured to provide output power from the UPS 101 to the load 126. In some examples, the output 106 may receive output power from the output interface 120 and provide the output power to the load 126. In some examples, the output 106 may also receive power from the load 126.

The sensor 108 is configured to detect characteristics (such as voltages, currents, frequencies, temperatures, and so forth) of power provided to or by the UPS 101. In some examples, the sensor 108 is configured to detect at least a voltage of the first input power received at the first input 102. In some examples, the sensor 108 may be configured to detect characteristics of power at any input or output of the UPS 101, or on and/or at any internal component or bus of the UPS 101. The sensor 108 may be configured to provide the sensed characteristics to the controller 122.

The first interface 112 is configured to receive the first input power from the first input 102 and to condition the first input power to produce first conditioned power. For example, the first interface 112 may condition the first input power from a first voltage to a second voltage, or from AC to DC, or DC to DC, and so forth. The first interface 112 may then provide the first conditioned power to the flow circuit 116.

The second interface 114 is configured to receive second input power from the second input 104 and to condition the second input power to produce second conditioned power. For example, the second interface 114 may condition the second input power from one voltage to another voltage, or from AC to DC, or DC to DC, and so forth. The second interface 114 may then provide the second conditioned power to the flow circuit 116.

The first interface 112 and the second interface 114 may differ in some examples. For example, the first interface 112 may be rated to receive first input power having a different voltage range or amperage compared to the second interface 114. In some examples, the first interface 112 may include a DC/DC converter while the second interface 114 may include an AC/DC converter. In other examples, the first interface 112 may be an AC/DC converter and the second interface 114 may be a DC/DC converter.

The flow circuit 116 is configured to manage the flow of the first conditioned power and the second conditioned power within the system. The flow circuit 116 may direct some or all of the first conditioned power and/or second conditioned power to the controller 122, the output interface 120, and/or the storage interface 118. In some examples, the flow circuit 116 may direct power according to a hierarchy.

The storage interface 118 protects the storage device 128 and the internal storage 132. For example, the storage interface 118 may include switches, trickle chargers, and/or other components that prevent the storage device 128 and the internal storage 132 from being charged beyond a rated charge level and discharged below a rated discharge level. For example, the storage interface 118 may control whether a conducting path to the storage device 128 from the UPS 101 is available or not, for instance, by opening or closing a switch, relay, or other circuit element. The storage interface 118 may also monitor the capacity and/or state-of-charge (“SOC”) of the storage device 128 and the internal storage 132, and provide the SOC information to the controller 122. In some examples, the storage interface 118 may include a management system (for example, a battery management system [BMS]) for the storage device 128 and/or the internal storage 132. In some examples, such as those where the storage device 128 and the internal storage 132 include the energy-storage interface of their own, the storage interface 118 may be omitted from the UPS 101.

The output interface 120 may include a converter configured to condition the first conditioned power, second conditioned power, and/or the power derived from the stored energy to produce the output power and provide the output power to the output 106. The output interface 120 may be a DC/DC converter, a DC/AC converter, an AC/DC converter, or any other type of converter. The output interface 120 may condition the first conditioned power, second conditioned power, and/or the power derived from the stored energy to produce output power rated for use by the load 126.

The controller 122 controls the operation of the UPS 101. The controller 122 may be coupled to any component of the power train 110 and to the sensor 108. In some examples, the controller 122 may be configured to communicate with the storage device 128 and the internal storage 132, the load 126, and/or the power sources 124, 130.

As discussed above, in some examples, the main power source 124 may include an AC/DC converter configured to be coupled to an AC utility grid. For example, the load 126 may be a DC load that is sold with an AC/DC converter to enable the load 126 to receive power derived from an AC utility grid. However, the main power source 124 may be rated to provide roughly the rated power of the load 126, such that minimal residual power is available to recharge the storage device 128 and/or the internal storage 132. In various examples, therefore, the UPS 101 may draw additional power from the secondary power source 130. The additional power may be used to recharge the storage device 128 and/or the internal storage 132 as well as to power the load 126. Accordingly, even if the main power source 124 is rated to provide roughly the rated power of the load 126, the UPS 101 may still quickly recharge the storage device 128 and/or the internal storage 132 using power derived from the secondary power source 130.

In some examples, the UPS 101 is a DC/DC UPS system. That is, in some examples, one or both of the first interface 112 and the second interface 114 receives DC power only, and the output interface 120 provides DC power only. In such examples, the first interface 112 is a DC/DC converter and the output interface 120 is a DC/DC converter, and the second interface 114 may be a DC/DC converter as well.

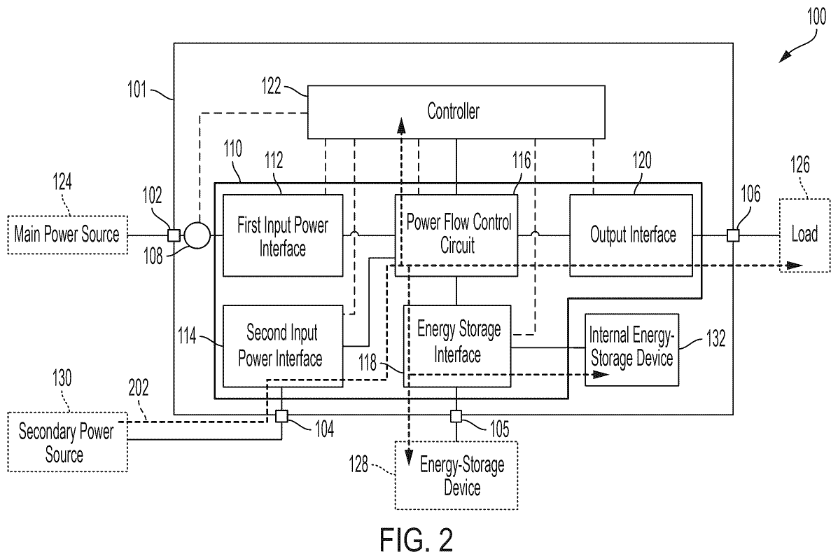

FIG. 2 illustrates the power system 100 of FIG. 1 according to an example. FIG. 2 is identical to FIG. 1 except that FIG. 2 adds a power flow trace 202 showing the flow of second input power from the secondary power source 130 through the second interface 114 and then to potential destinations within the UPS 101. The power flow trace 202 shows power originating at the secondary power source 130, passing through the second input 104 to the second interface 114, then reaching the flow circuit 116. The flow circuit 116 may divide the power in portions to be provided to the controller 122, the storage interface 118, and the output interface 120.

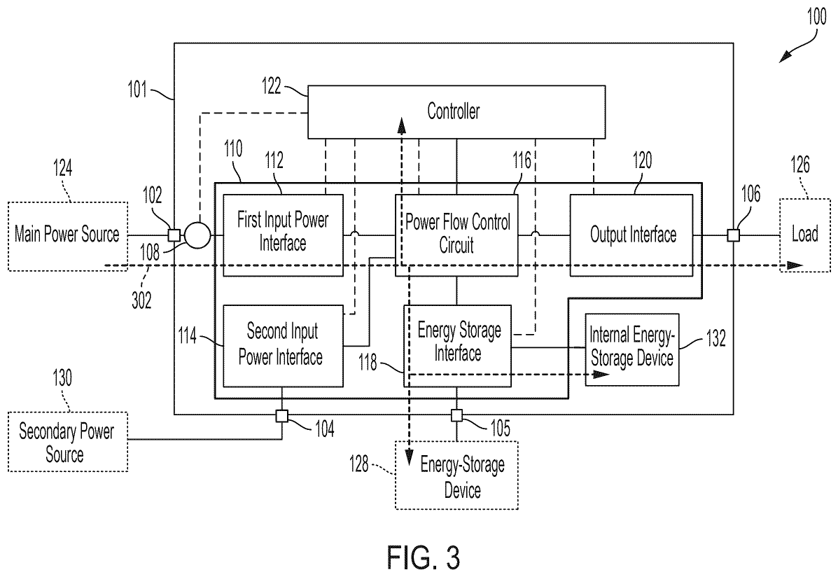

FIG. 3 illustrates the power system 100 of FIG. 1 according to an example. FIG. 3 is identical to FIG. 1 except that FIG. 3 adds a power flow trace 302 showing the flow of first input power from the main power source 124 through the first interface 112 and to various destinations within the UPS 101. The power flow trace 302 shows power originating at the main power source 124, passing through the first input 102 and first interface 112, and reaching the flow circuit 116. The flow circuit 116 may divide the power in portions to be provided to the controller 122, the storage interface 118, and the output interface 120.

In some examples, the power flow traces 202, 302 of FIGS. 2 and 3 may correspond to conducting paths from respective power sources to respective destinations that are entirely independent from one another. That is, in some examples, the power flow traces 202, 302 illustrate conducting paths of power derived from only one of the main power source 124 or the secondary power source 130, but not both. Thus, the power flow traces 202, 302 may represent power paths that are separated from one another in space (that is, via different physical conductors), time (that is, via the same or different physical conductors, but not at the same time), or both. For example, independent handling of the first input power and the second input power (that is, power derived from the main power source 124 and power derived from the secondary power source 130, respectively) may mean that the first input power and second input power are never mingled together on a common bus or at a common node. Instead, the conducting paths for the first input power and second input power may be distinct and separate.

In other examples, the first input power and second input power may not be independent, such that the first input power and second input power overlap in time and space at a common bus or node (that is, are flowing through the same physical conducting path at the same time). For example, the physical conducting paths for the first input power and the second input power may be the same once the power reaches the flow circuit 116, but may be independent before reaching the flow circuit 116.

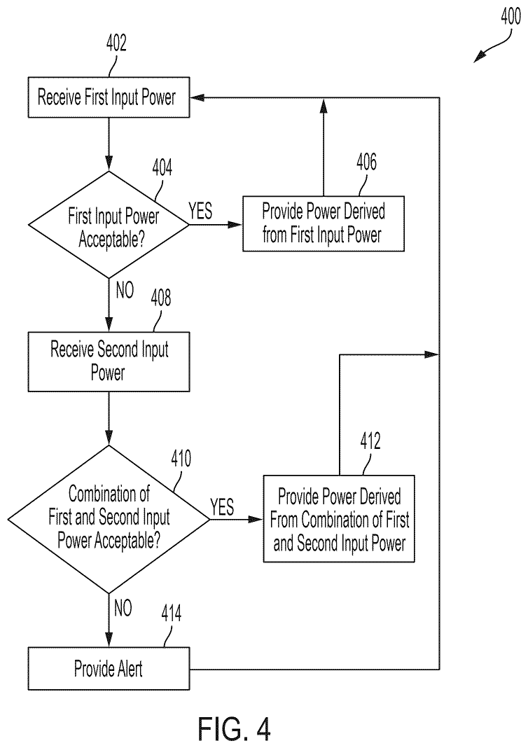

FIG. 4 illustrates a process 400 for providing power derived at the first input 102 and second input 104 to the load 126, the controller 122, and/or the storage device 128 and/or the internal storage 132 according to an example. The process 400 illustrates one example of how the UPS 101 can supplement the main power source 124 with additional power from the secondary power source 130.

At act 402, the UPS 101 receives first input power at the first input 102. For example, the first input power may be provided by the main power source 124. The process 400 then continues to act 404.

At act 404, the controller 122 determines whether the first input power is above a threshold power level. The controller 122 may be tasked with ensuring that the load 126 (and/or components of the UPS 101 itself, such as the controller 122) is fully powered and, if the storage device 128 and the internal storage 132 are not fully charged, that the storage device 128 and the internal storage 132 are being effectively charged. Accordingly, the threshold power level may represent an amount of power to effectively power the load 126 and, if the storage device 128 and the internal storage 132 are not fully charged, to recharge these storage devices. In some examples (for example, if the storage device 128 and the internal storage 132 are not fully charged), the threshold power level may be based on (for example, may be equal to) a sum of the rated power of the load 126 and the rated charging power of the storage device 128. In various examples (for example, if the storage device 128 and the internal storage 132 are fully charged), the threshold power level may be equal to the rated power of the load 126. Accordingly, the threshold power level may change over time based at least on whether the storage device 128 and the internal storage 132 are fully charged. If the controller 122 determines that the first input power is acceptable (for example, by determining that the first input power is above the threshold power level) (404 YES), the process 400 continues to act 406. If the controller 122 determines that the first input power is not acceptable (for example, by determining that the first input power is below the threshold power level) (404 NO), the process 400 continues to act 408.

At act 406, the controller 122 controls the UPS 101, including any component of the power train 110 or the power train 110 as a whole, to provide at least a portion of the first input power to the load 126 and/or the storage device 128 and/or the internal storage 132. In some examples, the controller 122 may also control the first interface 112 and the flow circuit 116 to provide at least a portion of the first input power to the controller 122 itself. The controller 122 may control the UPS 101 to provide any portion of the first input power to the load 126, storage device 128 and/or the internal storage 132, and/or controller 122 itself. For example, the entirety of the first input power may be provided to the load 126, or the first input power may be split into portions destined for the load 126, storage device 128 and/or the internal storage 132, and/or controller 122. The process 400 may then return to act 402. In some examples, if the controller 122 determines that the first input power is acceptable at act 404, then during act 406 the first input power may be provided to the controller 122, the load 126, and/or the storage device 128 and/or the internal storage 132.

At act 408, the controller 122 controls the UPS 101 to draw second input power at the second input 104. For example, the controller 122 may control the second interface 114 to draw the second input power from the secondary power source 130. The process 400 may then continue to act 410.

At act 410, the controller 122 determines whether the second input power in combination with the first input power is acceptable to power the load 126 along with the controller 122 itself, and/or recharge the storage device 128 and/or the internal storage 132. For example, the controller 122 may determine whether a sum of the first input power and the second input power is above a threshold power level based on a rated power of the load 126 and a rated recharging level of the storage device 128 and the internal storage 132. If the combination of the first input power and the second input power is acceptable (410 YES), the process 400 may continue to act 412. Otherwise, if the combination of the first input power and the second input power is not acceptable (410 NO), the process 400 may continue to act 414.

At act 412, the controller 122 directs appropriate portions of the combination of first and second input power to one or more of the load 126, the controller 122 itself, storage device 128 and/or the internal storage 132. In some examples, portions of the first input power and portions of the second input power may be provided to the load 126, the storage device 128 and/or the internal storage 132, and/or the controller 122 at the same time, such that the first input power and the second input power may be considered to be at least partially mixed together. The process 400 may then return to act 402.

In some examples, the process 400 of FIG. 4 may not be limited to receiving the first and second input power and providing combination or portions thereof to one or more of the controller 122, load 126, storage device 128 and/or the internal storage 132. For example, the process 400 of FIG. 4 may derive power from the energy stored in storage device 128 and/or the internal storage 132, and provide combination or portions of the power thus derived to the controller 122 and/or load 126.

Returning to act 410, if the combination of the first input power and the second input power is not acceptable (410 NO), then the process 400 continues to act 414. At act 414, the controller 122 generates an exception, alert, or other indication that the power is not acceptable to power the load 126 and recharge the storage device 128 and the internal storage 132. The indication may be any type of signal, for example, an alarm (such as light, sound, tactile, and so forth), a notification (for example, an email provided to an administrator), one or more packets containing relevant information, and so forth. The indication may provide additional information, such as the power deficit, any other errors relating to the operation of the UPS 101, and any other information relevant to determining why power may be unacceptable (such as impedances that may reflect power line connectivity, and so forth). The process 400 may then return to act 402.

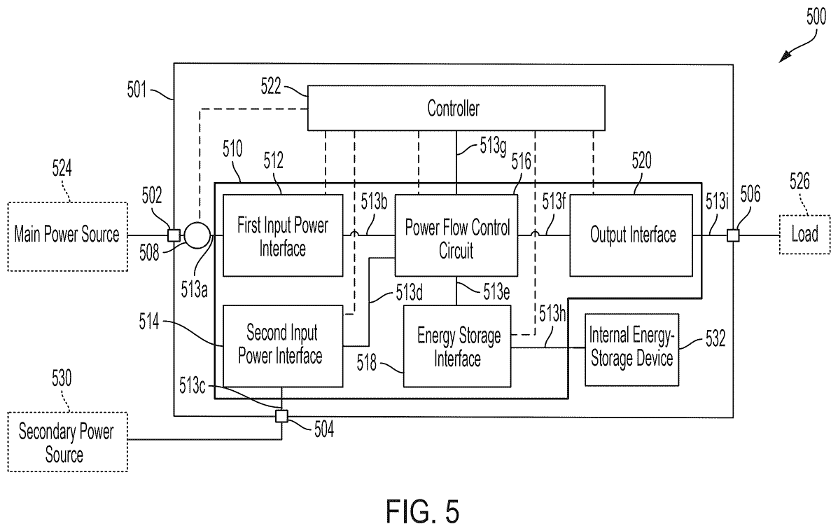

FIG. 5 illustrates a power system 500 for powering a load 526 using an uninterruptible power supply 501 (“UPS 501”) according to an example. The power system 500 includes a UPS 501 having a first input 502, a second input 504, an output 506, one or more sensors 508 (“sensor 508”), and a power train 510. The power train 510 includes a first input power interface 512 (“first interface 512”), a second input power interface 514 (“second interface 514”), a power flow control circuit 516 (“flow circuit 516”), an energy-storage-device interface 518 (“storage interface 518”), and an output interface 520. The UPS 501 also includes at least one controller 522 (“controller 522”), and at least one internal energy-storage device 532. The power system 500 also includes a main power source 524, one or more loads 526 (“load 526”), and a secondary power source 530.

The UPS 501 is configured to be coupled to the main power source 524 via the first input 502. The first input 502 is configured to be coupled to the main power source 524, and is coupled to the first interface 512 (and therefore to the power train 510). The first input 502 may also be coupled to the sensor 508. For example, the sensor 508 may be configured to sense parameters related to a connection (for example, first connection 513a) between the first input 502 and the first interface 512, such as a voltage and/or current on the connection. For example, the sensor 508 may include a sensor coupled in series between the first input 502 and the first interface 512 (for example, where the sensor 508 includes a current sensor to sense a current from the first input 502 to the first interface 512), and/or may include a sensor coupled in parallel with the first connection 513a (for example, where the sensor 508 includes a voltage sensor to sense a voltage on the first connection 513a).

The first interface 512 is coupled to the flow circuit 516 via a second connection 513b, and to the first input 502 via the first connection 513a. The second interface 514 is coupled to the second input 504 via a third connection 513c, and to the flow circuit 516 via a fourth connection 513d. The second input 504 is configured to be coupled to the secondary power source 530, and is coupled to the second interface 514.

The flow circuit 516 is coupled to the first interface 512 via the second connection 513b, to the second interface 514 via the fourth connection 513d, to the storage interface 518 via a fifth connection 513e, to the output interface 520 via a sixth connection 513f, and to the controller 522 via a seventh connection 513g.

The storage interface 518 is coupled to the flow circuit 516 via the fifth connection 513e and to the internal energy-device 532 via a eighth connection 513h.

The output interface 520 is coupled to the output 506 via a ninth connection 513i and to the flow circuit 516 via the sixth connection 513f. The output 506 is coupled to the output interface 520 and is configured to be coupled to the load 526.

The controller 522 is coupled to the flow circuit 516, and may be coupled (for example, communicatively coupled) to any component of the UPS 501, including but not limited to the sensor 508, the power train 510, the first interface 512, the second interface 514, the output interface 520, and/or the storage interface 518.

The main power source 524 may be the primary power source for the load 526. The main power source 524 may be a utility mains power line, a power generator or power plant, or any other source of power. Power provided by the main power source 524 may be converted by a power converter configured to convert main power to a form acceptable for use by the UPS 501 or the load 526. Accordingly, the main power source 524 can provide AC power that is converted into DC power prior to being provided to the UPS 501. The power provided by the main power source 524 is provided at the first input 502 of the UPS 501.

The secondary power source 530 is a power source that provides power to the second input 504. In some examples, the secondary power source 530 may include an AC/DC converter designed to convert AC power into DC power rated for use by the UPS 501 or the load 526.

The load 526 consumes power output by the UPS 501 at the output 506. The load 526 may be any device that uses power to operate, for example, a light, a computer, an appliance, a data server, or any other type of electronic device.

The internal energy-storage device 532 stores energy. Stored energy may be derived via power from the first input 502 and/or the second input 504. The internal energy-storage device 532 may be any type of device capable of storing energy, such as a battery. In some modes of operation, the internal energy-storage device 532 may provide power for the load. For example, the internal energy-storage device 532 may provide energy to the storage interface 518, which may provide the energy to the flow circuit 516. The flow circuit 516 may then distribute the energy to the controller 522 and the output interface 520. The output interface can then provide the power to the load 526 via the output 506.

In some examples, power from the main power source 524 and/or secondary power source 530 may be provided to the load 526, and/or the internal energy-storage device 532. In some examples, the main power source 524 may be able to provide enough power to power the load 526 but not enough power to effectively charge the internal energy-storage device 532. In examples where the main power source 524 cannot provide enough power to both power the load 526 and effectively charge the internal energy-storage device 532, additional power may be drawn from the secondary power source 530 to power the load 526 and charge the internal energy-storage device 532.

As noted above, the UPS 501 may receive power from the secondary power source 530 via the second input 504. The UPS 501 may also transmit and/or receive data via the second input 504. For example, the second input 504 may include a USB connection and/or another connection with the capability to receive and/or transmit data. The UPS 501 may receive information at the second input 504 (including, for example, updates to the UPS 501) or transmit information to one or more external devices via the second input 504. Accordingly, while the second input 504 is referred to as an “input” for purposes of brevity, in some examples, information may be transmitted from the UPS 501 via the second input 504.

The second input 504 may transmit and/or receive information to or from devices other than, and/or in addition to, the secondary power source 530. For example, the UPS 501 may receive information such as firmware updates to the controller 522. The UPS 501 may transmit, via the second input 504, information including power characteristics, such as voltage, current, frequency, load characteristics, and other traits of the power system 500 to external devices. In some examples, the second input 504 may be used as a user interface for operating the UPS 501, including by setting the configurable parameters of the UPS 501, such as the output voltage, output current limit, output power limit, and so forth. In other examples, the second input 504 may be used to transmit information about the UPS 501, such as the battery status, output power, backup time, temperature, and so forth, to external devices.

In some examples, the UPS 501 may also be able to receive power from the load 526 at the output 506 and provide power received at the output 506 to the internal energy-storage device 532 and/or power sources 524, 530. For example, if the load 526 is a regenerative load, then the load 526 may generate excess power that may be returned to the main power source 524 or stored for later use.

The first input 502 is configured to receive first input power from a power source such as the main power source 524. The second input 504 is configured to receive second input power from a power source such as the secondary power source 530. The output 506 is configured to provide output power from the UPS 501 to the load 526.

The sensor 508 is configured to detect characteristics (such as voltages, currents, frequencies, temperatures, and so forth) of power provided to or by the UPS 501. In some examples, the sensor 508 is configured to detect at least a voltage of the first input power received at the first input 502. In some examples, the sensor 508 may be configured to detect characteristics of power at any input or output of the UPS 501, or on and/or at any internal component or bus of the UPS 501. The sensor 508 may be configured to provide the sensed characteristics to the controller 522.

The first interface 512 is configured to receive the first input power from the first input 502 and to condition the first input power to produce first conditioned power. For example, the first interface 512 may condition the first input power from a first voltage to a second voltage (for example, a first DC voltage to a second DC voltage). The first interface 512 may then provide the first conditioned power to the flow circuit 516.

The second interface 514 is configured to receive second input power from the second input 504 and to condition the second input power to produce second conditioned power. For example, the second interface 514 may condition the second input power from one voltage to another voltage (for example, from one DC voltage to another DC voltage). The second interface 514 may then provide the second conditioned power to the flow circuit 516.

The first interface 512 and the second interface 514 may differ in some examples. For example, the first interface 512 may be rated to receive first input power having a different voltage range or amperage compared to the second interface 514. In other examples, the interfaces 512, 514 may be rated to receive power having substantially similar characteristics.

The flow circuit 516 is configured to manage the flow of the first conditioned power and the second conditioned power within the UPS 501. The flow circuit 516 directs some or all of the first conditioned power and/or second conditioned power to the controller 522, the output interface 520, and/or the storage interface 518.

The storage interface 518 manages charging and discharging of the internal energy-storage device 532. For example, the storage interface 518 may include one or more switches, trickle chargers, and/or other components that prevent the internal energy-storage device 532 from being charged beyond a rated charge level and discharged below a rated discharge level. For example, the storage interface 518 may control whether a conducting path between the internal energy-storage device 532 and the flow circuit 516 is available or not, for instance, by opening or closing a switch, relay, or other circuit element. The storage interface 518 may also monitor the capacity and/or state-of-charge (SOC) of the internal energy-storage device 532, and provide the SOC information to the controller 522.

In some examples, the storage interface 518 may condition the power it receives from the flow circuit 516, and provide conditioned power to the internal energy-storage device 532. In other examples, the storage interface 518 may condition stored power it receives from the internal energy-storage device 532 and provide the conditioned stored power to the flow circuit 516. In some examples, the storage interface 518 may include a management system, for example, a battery management system (BMS) for the internal energy-storage device 532. In other examples, such as those where the internal energy-storage device 532 includes the BMS of its own, the storage interface 518 may be omitted from the UPS 501.

The output interface 520 may include a converter configured to condition the first conditioned power, the second conditioned power, and/or the power derived from the stored energy to provide to the output 506. The output interface 520 conditions the first conditioned power, second conditioned power, and/or the power derived from the stored energy to produce output power rated for use by the load 526. The output interface 520 may include a DC/DC converter.

The controller 522 controls operation of the UPS 501. The controller 522 may be coupled to any component of the power train 510 and to the sensor 508. In some examples, the controller 522 may be configured to communicate with the internal energy-storage device 532, the load 526, and/or the power sources 524, 530.

As discussed above, the main power source 524 may include an AC/DC converter configured to be coupled to an AC utility grid. For example, the load 526 may be a DC load that is sold with an AC/DC converter to enable the load 526 to receive power derived from an AC utility grid. However, the AC/DC converter may be rated to provide roughly the rated power of the load 526, such that minimal residual power is available to charge the internal energy-storage device 532. In various examples, therefore, the UPS 501 may draw additional power from the secondary power source 530 to, in some examples, supplement the residual power. The additional power may be used to charge the internal energy-storage device 532 as well as to power the load 526. Accordingly, even if the main power source 524 is rated to provide roughly the rated power of the load 526, the UPS 501 may still quickly charge the internal energy-storage device 532 using power derived from the secondary power source 530.

In some examples, the UPS 501 is a DC/DC UPS system. That is, in some examples, one or both of the first interface 512 and the second interface 514 receives DC power only, and the output interface 520 provides DC power only. In such examples, the first interface 512 is a DC/DC converter and the output interface 520 is a DC/DC converter, and the second interface 514 may be a DC/DC converter as well.

In some examples, the power system 500 may include an external energy-storage device (not shown), such as a battery. For example, the UPS 501 may be coupled to the external energy-storage device (not shown) via a suitable connection, such as a connection via the storage interface 518. In various examples, the UPS 501 may be coupled to the external energy-storage device (not shown) in addition to, or in lieu of, the UPS 501 including the internal energy-storage device 532.

In various examples, the second interface 114 may be configured to receive power transmitted according to a different standard than that of the first interface 112. For example, the first input 102 may be a pin input (such as a power pin) or plug (such as a 3-prong plug or a 2-prong plug). The second input 104 may be a USB input, such as USB-C, or may be a different standard than the first input 102. Accordingly, the first interface 112 corresponding to the first input 102 may be configured to condition power received according to the standard of the first input 102 (that is, the first interface 112 may be configured to receive and condition power delivered by a plug or pin input), while the second interface 114 may be configured to condition power received according to the standard of the second input 104 (that is, the second interface 114 may be configured to receive and condition power delivered by a USB connection or other type of input different from that of the first input 102). In some examples, the second input 104 may be a plug or power pin, and the second input 104 may accommodate a different standard or set of standards compared to the first input 102 (that is, sets of standards may overlap provided there is at least some difference between them). In other examples, the second input 104 may be configured to receive power according to the same standard (or set of standards) as the first input 102.

In some examples, the first interface 112 and the second interface 114 both produce conditioned power having identical or similar characteristics. For example, the first conditioned power and the second conditioned power may both be DC or AC, may both have identical voltage and/or amperage, and so forth. In some examples, the first interface 112 and second interface 114 produce the conditioned power such that the first conditioned power and second conditioned power have one or more characteristics within a threshold amount of each other (for example, 20%, 1%, 0.05%, and so forth).

In the above description, functions of the power system 100 shown in FIGS. 1, 2, 3 and the process 400 shown in FIG. 4 have been explained for receiving input power from two sources and providing output power to a single load. In some examples, the power system 100 and the process 400 may not be limited to receiving input power from two sources and providing output power to a single load. Instead, the concept explained in the above description is extendible to a power system consisting of more than two sources and more than one load.

The controller 122 may be configured to control the flow circuit 116 to provide power to the controller 122 first, the load 126 second, and to recharge the storage device 128 third. In other examples, the controller 122 may be configured to control the flow circuit 116 to provide power the load 126 first, the controller 122 second, and the storage device 128 third, and so forth. The flow circuit 116 may have one or more conducting paths within it and/or associated with it, such that the flow circuit 116 can direct the first conditioned power separately from and/or independently of the second conditioned power. The flow circuit 116 may also have one or more conducting paths that allow the first conditioned power and second conditioned power to mingle together, the aggregate of the first conditioned power and second conditioned power then be directed by the flow circuit 116 to other circuit components.

Various controllers, such as the controller 122, may execute various operations discussed above. Using data stored in associated memory and/or storage, the controller 122, also executes one or more instructions stored on one or more non-transitory computer-readable media, which the controller 122, may include and/or be coupled to, that may result in manipulated data. In some examples, the controller 122, may include one or more processors or other types of controllers. In one example, the controller 122, is or includes at least one processor. In another example, the controller 122, performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware or hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. An uninterruptible power supply (UPS) comprising:
a first input configured to receive first DC power;
a second input configured to receive second DC power;
an output configured to provide a first output DC power to a load; and
a power train including at least one energy-storage interface configured to be coupled to an energy-storage device, the power train being coupled to the first input, the second input, and the output, and being configured to
direct at least a portion of the first DC power from the first input to the output to provide the first output DC power to the load, and
direct, via the at least one energy-storage interface, the second DC power as a second output DC power to the energy-storage device.

2. The UPS of claim 1 wherein the power train includes a first path for the first DC power and a second path for the second DC power.

3. The UPS of claim 2 wherein:
the first path is configured to receive the first DC power and provide the first DC power to a common conducting path; and
the second path is configured to receive the second DC power and provide the second DC power to the common conducting path.

4. The UPS of claim 2 wherein the first path and the second path are independent of one another.

5. The UPS of claim 1 wherein the power train further comprises:
a power interface coupled to the first input and configured to receive the first DC power from the first input; and
an output interface coupled to the output and configured to receive the portion of the first DC power and provide the output DC power to the output.

6. The UPS of claim 5 wherein the output interface is further configured to condition power provided by the power interface to have a voltage rated for use by the load.

7. The UPS of claim 1 wherein the at least one energy-storage interface is further configured to condition power to have a voltage rated for use by the energy-storage device.

8. The UPS of claim 1 wherein the power train further comprises a power flow circuit coupled to the first input and the second input.

9. The UPS of claim 1 wherein the power train further comprises a power interface coupled to the second input and configured to receive the second DC power.

10. The UPS of claim 1 wherein the at least one energy-storage interface conditions the second DC power to be rated for the energy-storage device.

11. The UPS of claim 1 further comprising at least one controller, wherein the power train further comprises a power interface coupled to the first input and an output interface coupled to the output, and wherein the at least one controller is configured to:
control the power interface to condition the first DC power to provide first conditioned power;
control the output interface to condition at least a portion of the first conditioned power to provide the first output DC power to the output; and
control the at least one energy-storage interface to condition the second DC power to provide the second output DC power to the at least one energy-storage device.

12. The UPS of claim 1 further comprising at least one controller, wherein the at least one controller is configured to:
control the power train to provide the first output DC power such that the first output DC power includes a first portion of the first DC power and a first portion of the second DC power, and
control the power train to provide the second output DC power such that the second output DC power includes a second portion of the first DC power and a second portion of the second DC power.

13. The UPS of claim 1 further comprising at least one controller, wherein the at least one controller is configured to control the at least one energy-storage interface to condition the second output DC power to have a voltage rated for the energy-storage device.

14. The UPS of claim 1 wherein the second input is configured to perform at least one action from a list of actions including:
sending firmware updates,
sending user interface information,
sending configurable parameter values,
receiving firmware updates,
receiving user interface information, and
receiving configurable parameter values.

15. A method of managing power in an uninterruptible power supply having a first input, a second input, and an output configured to be coupled to a load, the method comprising:
receiving, at the first input, first DC power having a first voltage;
receiving, at the second input, second DC power having a second voltage;
responsive to receiving the first DC power, providing at least a portion of the first DC power to the load via the output; and
responsive to receiving the second DC power, providing the second DC power to an energy-storage device via an energy-storage interface.

16. The method of claim 15 further comprising:
responsive to receiving the first DC power, determining that a power level of the first DC power is below a threshold power parameter; and
responsive to determining that the power level of the first DC power is below the threshold power parameter, and prior to receiving the second DC power, operating a power interface to couple the second input to the energy-storage device.

17-18. (canceled)

19. The method of claim 15 further comprising:
deriving, by a power train, the first DC power from a first power source; and
deriving, by the power train, the second DC power from at least one second power source not including the first power source.

20. At least one non-transitory computer-readable medium containing thereon instructions for operating an uninterruptible power supply (UPS) including a first input, a second input, an output configured to be coupled to a load, and at least one energy-storage interface configured to be coupled to an energy-storage device, the instructions instructing at least one processor to control the UPS to:
receive, at the first input, first DC power having a first voltage;
receive, at the second input, second DC power having a second voltage;
responsive to receiving the first DC power, provide at least a portion of the first DC power to the load; and
responsive to receiving the second DC power, provide the second DC power to the energy-storage device via the energy-storage interface.

21. The at least one non-transitory computer-readable medium of claim 20 wherein the instructions further instruct the at least one processor to:
determine whether a power level of the first DC power is above a threshold power level; and
responsive to determining that the power level of the first DC power is below the threshold power level, and prior to receiving the second DC power, operate a power interface to couple the second input to the energy-storage device, wherein the power level is based on at least one member of a set comprising the first voltage, a current, and a power of the first DC power, and the threshold power level is a value corresponding to at least one of the first voltage, the current, or the power of the first DC power.

22. The at least one non-transitory computer-readable medium of claim 20 wherein the instructions further instruct the at least one processor to:
control the UPS to monitor the first DC power to determine whether a power level of the first DC power is above a threshold power level; and
responsive to determining that the power level is above the threshold power, control the UPS to stop drawing the second DC power.
